(19) United States
(12) Patent Application Publication
(10) Pub. No.: US 2018/0098910 A1
(43) Pub. Date: Apr. 12, 2018

(54) Rolling Back Healthcare Massage and Fitness Apparatus

(71) Applicant: Miaoliang LI, Riverside, CA (US)

(72) Inventor: Miaoliang LI, Riverside, CA (US)

(21) Appl. No.: 15/292,101

(22) Filed: Oct. 12, 2016

(51) Int. Cl. A61H 15/00; A61H 1/00

(52) U.S. Cl. CPC A61H 15/00; A61H 2205/081; A61H 1/006

(57) ABSTRACT

A rolling back healthcare massage and fitness apparatus is designed for a user to perform a flexing and extending movement and to back-massage at the same time, wherein the apparatus includes a supporting frame constructed to have an upper frame and a lower frame, a rolling back massaging arrangement extended between the upper and lower frames, and two handle units spacedly extended between the upper and lower frames. The rolling back massaging arrangement has a plurality of rolling back massaging faces that one of the rolling back massaging faces is selectively oriented for touching, rubbing and kneading on the user's back. The handle units not only allows the user's hands to hold at the handle units to perform the flexing and extending movement but also enables the user's body to self-apply a massaging pressure on the user's back at one of the rolling back massaging faces for back-massaging.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a fitness apparatus, and more particularly relates to a fitness apparatus with rolling back healthcare massaging arrangement, which allows the user to perform flexing and extending movement and to back-massage at the same time by self-help. In other words, the user's body flexing and extending movement will drives upper trunk to scroll back on the rolling back post to achieve healthcare massage of the spine and the body's back acupoints and meridians.

### Description of Related Arts

With the development of society, the pursuit of health and longevity of life is the ultimate goal of human longing. In the exploration of health promotion, human congenital physiological characteristics of intervertebral disk easily lead to diseases and aging, that is just beginning to be recognized by the medical profession. For most, it is still a blind spot especially for elder.

The human aging is from the beginning of spine. The experts and scholars of researching on human spine and health have pointed out the root causes of human aging and diseases are mainly due to spinal disease and aging. The medical profession has recognized that many chronic diseases are caused by spinal lesions. Germany spine expert, Prof. Dr. Juergen Kraemer said, “Disk diseases have existed since the dawn of humanity but are only just beginning to be understood.” “Controlled studies have revealed that every older person occasionally experiences low back pain. The lifetime prevalence of this symptom is thus 100%.” (A book: “Intervertebral Disk Diseases” Juergen Kraemer, MD. Copy right of the original English language edition 2009 by Georg Thieme Verlag KG, Stuttgart, Germany.)

As the disc closely related to spine in the infant of eight months, the blood supply has started to close in intervertebral disc, and spinal intervertebral disc in youth people has became none blood organization. But it is still adapted to upright walking with the various activities, particularly weight-bearing activities. Over the next human life, spinal disc depends the osmosis effect of semipermeable membrane of cartilage endplate, so that water and nutrients goes into the disc. The congenital physiological characteristics are likely to cause early disc degeneration, gradually increased with age, and irresistible. With the growth of the human life expectancy, people are more likely to face the threat of easily invasion of aging body and spine degenerative diseases. “Degenerative disturbances of the structure and function of the intervertebral disks have attracted a great deal of attention in recent decades, both because of their wide intrinsic variety and because of their widespread effects on other organs.” Therefore, how can we prevent easily leading to diseases and aging from human congenital physiological characteristics of the spine? This is a big self-challenge of human beings.

Prof. Dr. Juergen Kraemer has revealed the relationship between human body motion and disk physiology healthy: “Measurements of intradiscal pressure reveal that any lateral or anteroposterior bending movement of the trunk changes the overall mechanical stress on the intervertebral disk. Bodily movement thus causes fluid to move into and out of the disks, as well as to shift within the disks themselves.”

According to spinal physiological healthy theory of Prof. Dr. Juergen Kraemer, there are two important implications: First, it must be targeted to practice spinal movement. Second, the spinal movement is the body's own exercise, other artificial and auxiliary tools can't replace it. Another word, no any way can replace it.

Fitness has been a dramatically growth industry during the past decades. Currently, going to the gym is a popular youth fitness programs. Its sports equipment is based on building muscle and strength. Such equipment is not suitable for the healthcare needs of the elderly population. This area has not yet been a fitness equipment as healthcare for human spinal exercise, and massage of body's acupoints and meridians. Thus, those skilled in the art has been committed to the development of a simple structure, but also convenient, effective and popularize for spinal health and back healthcare massage. In real life, more young people goes into the gym. Elderly people rarely goes into the gym, and more into the hospital. The spending medical expenditure on the elderly is considerable every country in the world. The less factors of causing the elderly going to the gym are: gym equipments are not suitable for the elderly, and specifically the elderly going to the gym is not convenient. Therefore, an innovative fitness equipment not only is for the elderly in the gym, but also is for the family, thus expand to every household. This will be a breakthrough for current developing predicament of fitness equipments, and open up new market space.

Prof. Dr. Juergen Kraemer pointed out new trend of spine care: “The treatment of cervical syndromes, like that of lumbar syndromes, has changed in recent years. The passive treatments that were previously emphasized, such as massage, realignment, and cervical collars, have largely given way to active ones: gentle exercise and continued physical activity.”

Also, people, including sensor users and young users, would like to have a massage for relaxing and therapy purpose. Some studies showing that massage is one of an effective treatments for reducing stress, pain and muscle tension. It is extraordinarily useful to alleviate low-back pain and improve range of motion, which also increase the joint flexibility. But, in the manual massage, the body is at rest and a standstill, and passive state. According to new trend of medical spinal care, it needs new fitness apparatus and the body can be in dynamic and active state that the advantage is to stimulate the body's inherent potential to mobilize the body's own innate healing power. In fact, the manual massage service is in a particular place, and people need more economic costs and schedules, and it is limited to high consumer groups. These services can't meet the healthcare needs of the great majority of the people. Moreover, the human body is not suitable for manual massage everyday.

Electric massage chair is available and is considered as one of the massing device to provide a relaxing way to get a massage without going to a masseuse. Its major function is that the people lie on the chair for back massage to relax the body mainly. People can purchase one and use in the privacy at home or use one in a public place where they are set up to help people relax. However, people can't accurately contact acupoints and meridians for healthcare massage. Electric massage chair is a massaging type of comfortable and enjoyable. It is not belong to exercise fitness category. In addition, it is not only higher prices and to occupy the space, but also electromagnetic field generated by long-term use will affect human health. And it is not suitable for people to enjoy electric chair massage everyday.

On Sep. 30, 2015, the United Nations World Health Organization (WHO) issued a report of “World Aging and Health”: “60 years of age or older population will be double by 2050, today is the first time in history that most people can expect to live to 60 years of age. Thus the pressure on health, health systems, labor force and the state budget is enormous.”

Above all the mentioned issues, the elder user currently could hardly found an effective way to do exercise in a fitness center and get massage at home. As the population ageing is a modern society phenomenon, the healthcare of the elder people is getting more and more concern from every aspect of the whole society. It is to need innovative fitness apparatus that let the people do spinal exercise every day and get more benefits, special for elderly people.

In order to promote spinal health, the strengthening of spinal bone is very important. The “weight-bearing force” exercise is essential way to strengthen spinal bone and increase spinal bone density. “weight-bearing” exercise includes body parts contraction, pushing, hitting, kicking punching bags and etc. Since the human spine has congenital physiological characteristics, various activities of weight-bearing pressure on the spine from top to bottom in a vertical direction can be harmful by not producing a “weight-bearing” effect on the spine, but is likely to cause the lesion of disk herniation or disk can be tilted to the side. Therefore, the only way to carry out the exercise of spinal “weight-bearing” is performed from behind the body in a horizontal direction.

However, in the field of the body exercise for spine healthcare, so far it has not yet been a specific fitness equipment of spine healthcare in the world, And there is no fitness equipment special for the purpose of spinal “weight-bearing” exercise. Thus, innovative fitness equipment and a new approach has realistic significance, to help people find the way to win self-challenges of human beings.

### SUMMARY OF THE PRESENT INVENTION

The invention is advantageous in that it provides a fitness apparatus with rolling back healthcare massaging arrangement, which allows the user to perform flexing and extending movement and to back-massage at the same time by self-help. In other words, the user's body flexing and extending movement will drives upper trunk to scroll back on the rolling back post to achieve healthcare massage of the spine and the body's back acupoints and meridians.

Another advantage of the invention is to a fitness apparatus with rolling back healthcare massaging arrangement, wherein the user's spine leans against and press on the rolling back massaging post, and the crowded force of the rolling back massaging post produces the effects of the “weight-bearing” on spine, that can help to increase the density of spinal bone.

Another advantage of the invention is to a fitness apparatus with rolling back healthcare massaging arrangement, which is designed focusing all aspects of human spinal healthcare needs, that can comprehensively care human spine and healthcare massage of body's back acupoints and meridians, including promoting spinal blood circulation and dredging Qi-blood of the meridians, and enhancing spinal functions.

Another advantage of the invention is to a fitness apparatus with rolling back healthcare massaging arrangement, wherein the handle units have multiple functions of allowing the user's hands to hold at the handle units to perform the flexing and extending movement and enabling the user's body to push backward to self-apply a massaging pressure on the user's back at the rolling back massaging face for back-massaging. Therefore, the weight-bearing force can be selectively adjusted by the user himself or herself via the handle units.

Another advantage of the invention is to a fitness apparatus with rolling back healthcare massaging arrangement, wherein the rolling back massaging arrangement has a plurality of rolling back massaging faces that the user is able to easily and selectively orient one of said rolling back massaging faces for touching, rubbing and kneading on the user's back.

Another advantage of the invention is to a fitness apparatus with rolling back healthcare massaging arrangement, wherein different rolling back massaging faces provide different massaging abilities and strengths for fitting different needs and different areas of the user.

Another advantage of the invention is to a fitness apparatus with rolling back healthcare massaging arrangement, which is safe and convenient to use by the elder user at home.

Another advantage of the invention is to a fitness apparatus with rolling back healthcare massaging arrangement, which does not require excessive limb movement. Basically it does not consume physical, or limited physical consumption. This method can be based on everyone different physique to adjust the range of motion. Therefore, this moderate physical exercise is to adapt the elderly frail features. This method is not much on the weather requirements, and also it is in a limited space to exercise. Exercise can be done without leaving home. This kind movement can add and replenish the exercises of young people that just muscle and strength sports, because the spine care must start from youth, and also more suitable for the elderly a healthcare methods. “The natural course of degenerative changes in the intervertebral disk is to increase steadily from about age 20 until age 50-60, by which time disk degeneration has progressed to almost its final extent.”

Another advantage of the invention is to a fitness apparatus with rolling back healthcare massaging arrangement, which does not include any additional operating system, such as electronic control system or any electrical power, and the method of the rolling back healthcare massage is simple and easy to learn. It also has lower healthcare costs, one-time purchase at home, and can use all year round. There is no post-maintenance costs. Family members are free to arrange time to rolling back healthcare massage. Thus, a universal, adaptation in every home.

Another advantage of the invention is to a fitness apparatus with rolling back healthcare massaging arrangement, which can be formed by a series from simple to complex. The price can be meet to the demands and living conditions of different groups. From ordinary people can afford the price, to the multi-functional high price in order to adapt to all types of people and families.

Another advantage of the invention is to a fitness apparatus with rolling back healthcare massaging arrangement, which can be easily folded up into a compact unit for storage and carriage, and can be easily unfolded for exercising.

Another advantage of the invention is to provide a fitness apparatus with rolling back healthcare massaging arrangement, wherein no expensive or complicated structure is required to employ in the present invention in order to achieve the above mentioned objects. Therefore, the present invention successfully provides an economic and efficient solution for providing a simple configuration for the user, especially for the elder, to perform the flexing and extending movement and to have a back massaging at the same time, so as to achieve both fitness and health results in one single apparatus.

Collectively, the features of the inventive healthcare massage and fitness apparatus combines body exercise and back's massage that is based on modern medical science and the meridians theory of traditional Chinese medicine. It brings us three innovations: (i) New idea and practice of “Fitness+Healthcare”; (ii) New method of spine overall healthcare by self-help; and (iii) New market for the general public to participate in exercise combining healthcare massage, and making the new fitness equipment of exercise with healthcare massage into each family. Meanwhile, it helps us face realistic self-challenge of human beings and break developing predicament of fitness equipments.

Additional advantages and features of the invention will become apparent from the description which follows, and may be realized by means of the instrumentalities and combinations particular point out in the appended claims.

According to the present invention, the foregoing and other objects and advantages are attained by a rolling back healthcare massage and fitness apparatus for a user to perform a flexing and extending movement and to back-massage at the same time, comprising:

a supporting frame which comprises an upper frame and a lower frame;

a rolling back massaging arrangement extended between the upper frame and the lower frame, wherein the rolling back massaging arrangement has one or more rolling back massaging faces that one of the rolling back massaging faces is interchangeable and selectively oriented for touching, rubbing and/or kneading on the user's back; and

a handle frame which comprises two handle units spacedly extended between the upper frame and the lower frame at a position that the rolling back massaging arrangement is located between the handle units, wherein the handle units are arranged not only for allowing the user's hands to hold at the handle units to perform the flexing and extending movement but also for enabling the user's body to push backward so as to self-apply a massaging pressure on the user's back at one of the rolling back massaging faces for back-massaging.

In accordance with another aspect of the invention, the present invention comprises a flexing and extending exercising apparatus for a user to perform a crouching movement, comprising:

a supporting frame which comprises an upper frame and a lower frame;

a handle frame which comprises two handle units spacedly extended between the upper frame and a lower frame, wherein the handle units are arranged for guiding the user to perform a flexing and extending movement by griping the user's hands at the handle units; and

a built-in rolling back massaging arrangement extended between the upper frame and the lower frame, wherein the rolling back massaging arrangement has a rolling back massaging face for touching, rubbing and/or kneading on the user's back during the flexing and extending movement, such that the rolling back massaging arrangement is arranged for enabling the user to self-apply a massaging pressure on the user's back at the rolling back massaging face for back-massaging during the flexing and extending movement.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a rolling back healthcare massage and fitness apparatus according to a preferred embodiment of the present invention.

FIG. 2 illustrates the user using the rolling back healthcare massage and fitness apparatus for back massaging during a flexing and extending movement of the user according to the preferred embodiment of the present invention.

FIG. 3 illustrates the massaging meridian lines at the user's back to be selectively touched, rubbed and/or kneaded by the rolling back healthcare massage and fitness apparatus according to the preferred embodiment of the present invention.

FIG. 4 is an exploded perspective view of the sliding joint at the lower frame of the rolling back healthcare massage and fitness apparatus according to the preferred embodiment of the present invention.

FIG. 5 illustrates different rolling back massaging faces of the rolling back healthcare massage and fitness apparatus according to the preferred embodiment of the present invention.

FIG. 6 illustrates an alternative mode of the supporting frame of the rolling back healthcare massage and fitness apparatus according to the preferred embodiment of the present invention.

FIG. 7 illustrates a first alternative mode of the rolling back massaging arrangement of the healthcare massage and fitness apparatus according to the preferred embodiment of the present invention.

FIG. 8 illustrates a second alternative mode of the rolling back massaging arrangement of the rolling back healthcare massage and fitness apparatus according to the preferred embodiment of the present invention.

FIG. 9 illustrates a first alternative mode of the handle unit of the rolling back healthcare massage and fitness apparatus according to the preferred embodiment of the present invention.

FIG. 10 illustrates a second alternative mode of the handle unit of the rolling back healthcare massage and fitness apparatus according to the preferred embodiment of the present invention.

FIG. 11 illustrates a third alternative mode of the handle unit of the rolling back healthcare massage and fitness apparatus according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

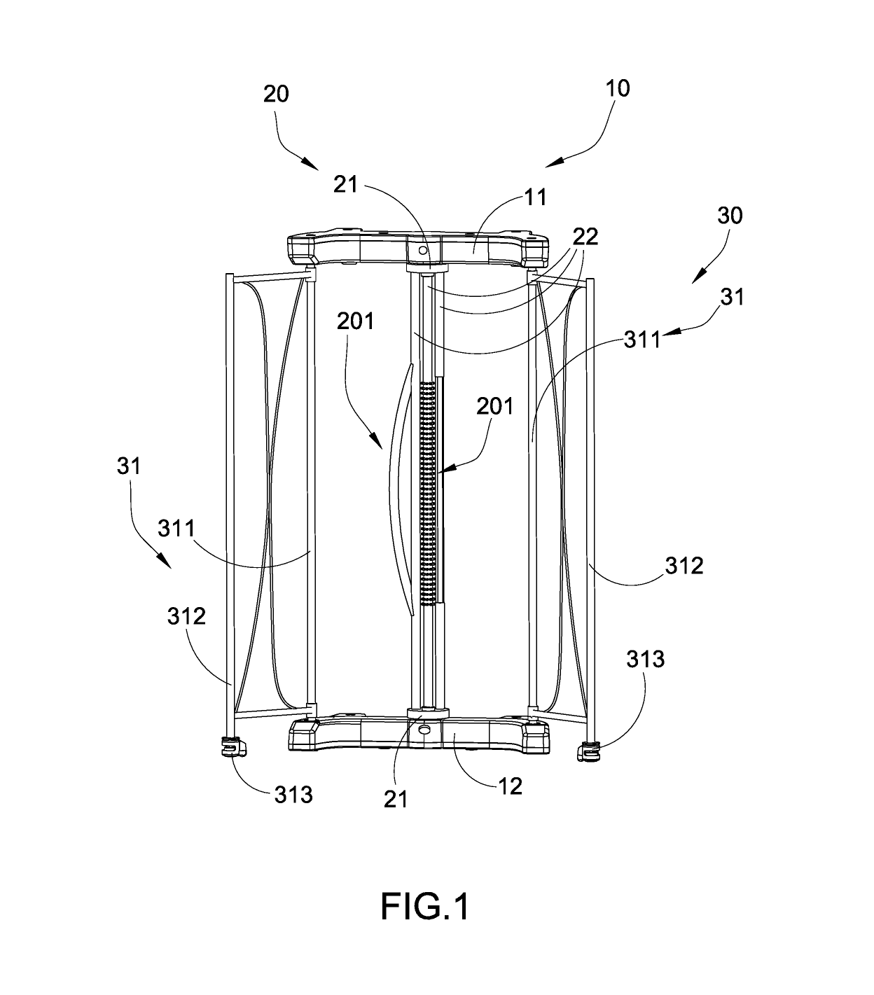

Referring to FIG. 1 of the drawings, a rolling back healthcare massage and fitness apparatus according to a preferred embodiment of the present invention is illustrated, wherein the purpose of this inventive apparatus is to help people doing spinal exercise and back's massage by themselves. The main features of the apparatus are “self-help” and natural that is the essence of green therapy. The term “self-help” refers to the apparatus requires the body's own movement to achieve the effects of back's massage. In this way, the body's own movement promotes blood circulation with dredging meridians Qi-blood that the body depends own energy and spirit to promote health. Other artificial and machine massage tools can't replace it. The term “natural” refers to the apparatus requires no mechanical power and no chemical aids. In this way, the body's own movement can stimulate body dynamic role to enhance innate ability of healing and more effectively promote health. At present, the other massages on the human body are mainly two types: the manual massage and electric massage chair. However, the apparatus of the present invention cannot be replaced by manual massage or electric massage chair. Because strengthening the strength of bone, muscle and ligament must be through body's own exercises. In addition, disc healthcare must be completed by the bending motion of own body.

The rolling back healthcare massage and fitness apparatus of the present invention includes two concepts to cover the method and practice of spine healthcare by self-help. The first concept is the “Fitness” that is the body exercises. The second concept is “Healthcare” that is to massage back's different acupoints and meridians, and they can care spine for external physical shape and location, and internal physiological functions. So, “Fitness” and “Healthcare” works together to complete the overall healthcare effects of the spine.

The body movements prevent and slow down the degenerative changes in the intervertebral disc. “Fitness” is throughout whole “Healthcare” that means the body movements being throughout whole process of spine overall healthcare.

The rolling back healthcare massage and fitness apparatus and its method has realized the relationship between human body motion and disc physiology healthy, that is disclosed by Prof. Dr. Juergen Kraeme. In the rolling back healthcare massage, the body bent forward and back extension will change the mechanical pressure of whole disc, so the body movement will cause body fluid inflow and outflow of the disc, and the body fluid is flowing between the discs. Also, favoring the nutrients are supplied to the disc. This will prevent and slow down human inevitable, premature degenerative changes in the intervertebral disc. Meanwhile, the muscles and ligaments of back's spine accordingly have been tempered.

According to different healthcare effects of back's acupoints and meridians, it can be divided into four aspects as second, third, fourth and fifth aspect, that are to massage specific acupoints and meridians, to achieve promoting overall health and enhancing spinal function, preventing and slowing down the spine aging. All these four aspects are interrelated and influence, and they are achieved by body movements. Here is just to introduce the emphasis of each aspect.

The second aspect is called “The through Governor Vessel”. The rolling back healthcare massage and fitness apparatus is based on Governor Vessel to increase the density of spinal bone. In order to increase the density of the human spine, the spine needs to be “loading capacity” in the exercises, that is “the bearing force”. “Loading capacity” exercises includes body parts contradict, push, hit, kicking to hard thing. Since the human spine congenital characteristics, various activities of weight-bearing pressure on the spine from top to bottom in vertical direction. It not only can't directly produce effect of spine “loading capacity”, but also likely to cause the lesion of disc herniation or tilted to the side. Therefore, the only way to carry out the exercise of spinal “loading capacity” is performed from the body behind in the horizontal direction. The rolling back healthcare massage can do this job.

Through the rolling back healthcare massage with present inventive apparatus, the body's spine pressures on the rolling back pole and the rolling back pole's tough produces the effects of “loading capacity” to the spine. Therefore, in the rolling back healthcare massage, the body flexing and extending not only to promote the metabolism of the intervertebral disc, and also it can have an effect of the “loading capacity” on the spine to increase the density of the spine, and delay spine aging.

In the rolling back healthcare massage, the rolling back post's crowded force presses the vertebrae, help to enhance bone and strength of muscle and ligaments of the spine, and help to prevent protruding behind of the vertebrae and reduce suffering from the symptoms of back protruding. When body's back scrolls the seventh cervical vertebra, “Li's method of the rolling back healthcare massage” requires that human chest forward to straighten and make the spine as inverse arcuate, and force the seventh cervical vertebra to contact the post more than 2 seconds. Every day doing rolling back healthcare massage can prevent kyphosis, but also to improve the hump has been suffering from kyphosis symptoms.

The third aspect is called “The correction of spine”. The rolling back healthcare massage is based on Jia-ji acupoints to prevent and improve the vertebrae displacing. In the rolling back healthcare massage, through symmetrical rolling back massage of the entire spine, spinal self-regulation of tension and relaxation of muscles on both sides, it helps to restore and maintain the balance of both sides of the spinal muscular, and prevent scoliosis. This process is similar to “The ridge chiropractic therapy”.

In addition, Jia-ji acupoints locate the spinous process downward of both sides on the spinal bone. There are 34 Jia-ji acupoints on both side of the spine. Jia-ji acupoints are also called Huatuo Jia-ji acupoints.

There is spinal nerve root under each Jia-Ji acupoint. The rolling back healthcare massage stimulates Jia-Ji acupoints and the information goes to the central nervous system through the communication pathways of the spinal cord, and regulates the central nervous system. The central nervous system goes through the spinal nerve downward to regulate peripheral nerves. So, the rolling back healthcare massage on Jia-Ji acupoints has a dual regulatory role for the central nervous system and peripheral nerve. The enhanced function of the body's nervous system can further promote the body's internal organs and viscera, and physical activity function.

The fourth aspect is called “The regulation of organs and viscera”. The rolling back healthcare massage is based on Back-shu acupoints to regulate and enhance the function of organs and viscera, and promote spinal health. Accordingly, the 12 pairs of Back-shu acupoints on both sides are corresponding to the human internal organs. The connection of back's acupoints, meridians and internal organs manifests the reflex point of body's nerve. The meridian theory of TCM and modern medicine believes that the Back-shu acupoints are the reflex points of organs nerve on body's back. Modern research has found that the Back-shu acupoints can have very significant impact to their respective organs and viscera. Any lesions of organs and viscera can be found in the corresponding reflex point of nerve of the Back-shu acupoints. Meanwhile, through stimulating reflex points can react on corresponding organs and viscera in human body.

So under normal conditions, massage Back-shu acupoints can adjust and promote physiological functions of organs and viscera. Under pathological conditions, it can varying degrees promote the function of organs and viscera to restore physiological balance. The rolling back healthcare massage can adjust the function of organs and viscera by stimulation of Back-shu acupoints. The enhanced function of organs and viscera will promote human blood circulation, metabolism and regulate the balance of matter and energy. Thus contributing to increase the generation of the spinal cord and spinal bone density, further enhance the spinal function, reduce spinal recession and delay aging.

The fifth aspect is called “The regulation of internal and external”. The rolling back healthcare massage is based on Bladder meridian of Foot-Taiyang which includes Back-shu acupoints and coordinates other meridians to overall enhance the body's energy as well as regulate and promote the function of the nervous system.

In rolling back healthcare massage, it requires the toes grasping the floor, and uses muscle strengths to irritate the end acupoint to Zhi-Yin acupoint of Bladder Meridian. In this way not only help to stimulate Bladder Meridian, but also stimulates Kidney Meridian, Stomach Meridian, Spleen Meridian, Bladder Meridian and Liver Meridian. Thereby it enhances the body's overall energy to adjust and adapt the external environment.

The trend of Governor Vessel and spinal nerves is towards the same direction. The pathway of Bladder Meridian of Foot-Taiyang, sympathetic nerve and cutaneous nerve of dorsal branch of spinal nerve is consistent. The rolling back healthcare massage is along the Governor Vessel and Bladder Meridian of Foot-Taiyang to help regulate and enhance the function of the nervous system.

Thus, due to combining “Fitness” and “Healthcare”, “The self-help method of spine overall healthcare” is not only including “hardware” that is spinal bone, intervertebral disc, spinal cord, nerves, blood vessels, muscles and ligaments, but also including “software” that is the body's blood circulation, metabolism and balance between matter and energy, and overall regulates the relationship between “software” and “hardware”. So, we can pride to say that with present invention, “The self-help method of spine overall healthcare” is a comprehensive method and practice of spine healthcare, and it will help human to win in the self-challenge of human beings.

According to the present invention, the rolling back healthcare massage and fitness apparatus is arranged for a user to perform a flexing and extending movement and to back-massage at the same time. Therefore, the apparatus of the present invention is also considered as a flexing and extending exercising apparatus, wherein the apparatus comprises a supporting frame 10, a rolling back massaging arrangement 20, and a handle frame 30. It is appreciated that the user, especially the youngster, can perform crouch or squat movement via the apparatus of the present invention.

As shown in FIG. 1, the supporting frame 10 comprises an upper frame 11 and a lower frame 12, wherein the upper frame 11 is supported above the lower frame 12 at a fixed distance therebetween. The supporting frame 10 defines a front side thereof, wherein the user stands at the front side of the supporting frame 10. In one embodiment, the supporting frame 10 is a stationary frame, wherein the upper frame 11 and the lower frame 12 are affixed on a wall surface to retain the distance therebetween via a wall mount 100. Preferably, each of the upper frame 11 and the lower frame 12 has an elongated structure and defines two outer ends.

The rolling back massaging arrangement 20, which is a built-in rolling back massaging arrangement, is extended between the upper frame 11 and the lower frame 12 of the supporting frame 10, wherein the rolling back massaging arrangement 20 has one or more rolling back massaging faces 201 that the rolling back massaging face 201 is oriented for touching, rubbing and/or kneading on the user's back. Preferably, the rolling back massaging arrangement 20 is extended between mid-portions of the upper frame 11 and the lower frame 12.

The handle frame 30 comprises two handle units 31, i.e. a right handle unit and a left handle unit, spacedly extended between the upper frame 11 and a lower frame 12 at a position that the rolling back massaging arrangement 20 is located between the handle units 31 to form the flexing and extending exercising apparatus. In particular, each of the handle units 31 is extended between the outer ends of the upper frame 11 and the lower frame 12. In other words, the rolling back massaging arrangement 20 and the handle units 31 are extended and supported between the upper frame 11 and a lower frame 12. Accordingly, the handle units 31 are arranged not only for allowing the user's hands to hold at the handle units 31 to perform the flexing and extending movement but also for enabling the user's body to push backward so as to self-apply a massaging pressure on the user's back at the rolling back massaging face 201 for back-massaging.

Accordingly, the human spinal flexing motion and the effects of “weight-bearing” of spine in the health campaigns. Through the flexing and extending movement of the user, the legs and trunk are together within the action that the legs movements drive upper body to rolling body's back to achieve healthcare massage. At the same time, the crowded force of the rolling back massaging face 201 on the spinal bone produces the effects of the weight-bearing on spine, that increase the density of spinal bone. Also, the stimulating effects of acupoints and meridians on body's back.

According to the preferred embodiment, one or more the rolling back massaging faces 201 are provided that the user is able to select one of the rolling back massaging faces 201 to be oriented for touching, rubbing and/or kneading on the user's back. It is worth mentioning that the touching, rubbing and/or kneading of each of the rolling back massaging faces 201 depends on the massaging pressure applied by the user.

In particular, the rolling back massaging arrangement 20 comprises two rotatable joints 21 rotatably coupled at the upper frame 11 and the lower frame 12, one or more of rolling back massaging posts 22 coupled between the rotatable joints 21, wherein the rolling back massaging faces 201 are formed at the rolling back massaging posts 21 respectively. Therefore, the rotatable joints 21 are rotated to selectively move one of the rolling back massaging posts 22 to orient the corresponding rolling back massaging face 201 for touching, rubbing and/or kneading on the user's back.

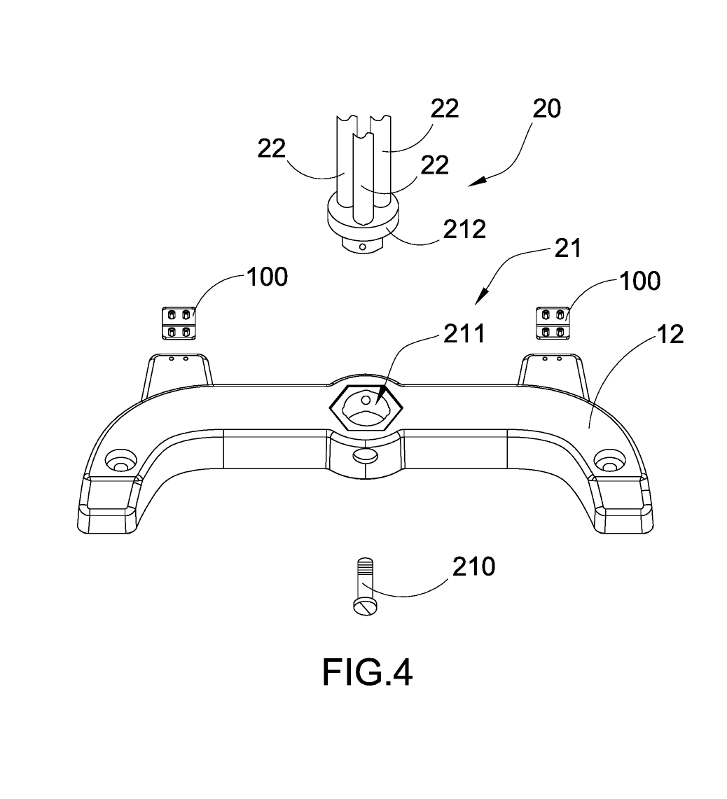

A joint cavity 211 is formed at each of the upper frame 11 and the lower frame 12. FIG. 4 illustrates the joint cavity 211 is formed at the lower frame 12, wherein each of the rotatable joints 21 has a disc shape rotatably coupled at the joint cavity 211. In particular, each of the rotatable joints 21 comprises a turntable 212 rotatably coupled at the corresponding upper frame 11 and the lower frame 12 at the joint cavity 211 thereat. Preferably, a bearing can be disposed between the rotatable joint 21 and an inner wall of the join cavity 211 to enhance the rotational movement of the rotatable joint 21.

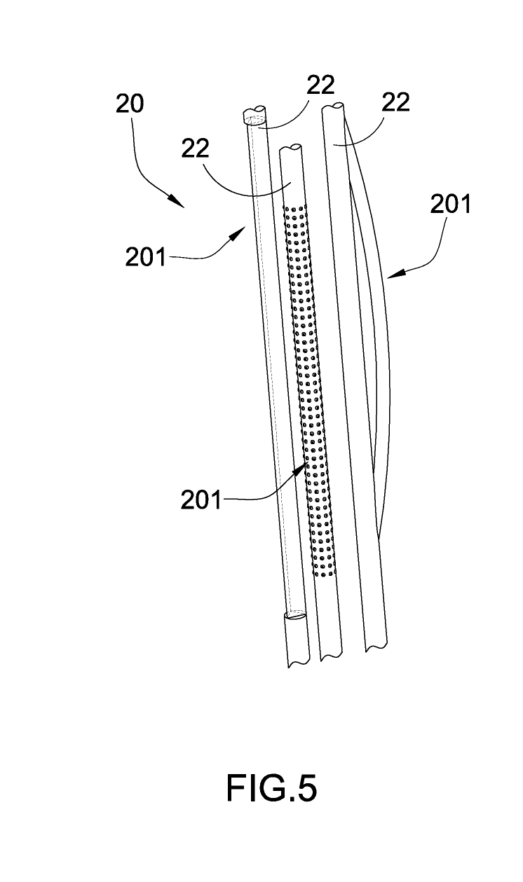

As shown in FIGS. 1 and 5, there are three rolling back massaging posts 22 to provide four different rolling back massaging face 201 that a post has two different massaging face, wherein the user is able to select one of the rolling back massaging faces 201 for back massaging. Accordingly, each of the rolling back massaging posts 22 has a post structure, which can a hollow post or a solid post, wherein upper ends of the rolling back massaging posts 22 are coupled at the rotatable joint 21 at the upper frame 11 and bottom ends of the rolling back massaging posts 22 are coupled at the rotatable joint 21 at the lower frame 12. In particular, the upper and bottom ends of rolling back massaging posts 22 are coupled at the rotatable joints 21 at a radial direction thereof. In other words, the rolling back massaging posts 22 are spacedly coupled at a circumferential portion of the turntable 212 to selectively orient the corresponding rolling back massaging face 201. Therefore, the three rolling back massaging posts 22 are rotated between the upper frame 11 and the lower frame 12 via the rotatable joints 21 to select one of the rolling back massaging posts 22 located at the front side of the supporting frame 10 for touching, rubbing and/or kneading on the user's back. In other words, the rest of the rolling back massaging posts 22 will be located behind the selected rolling back massaging post 22 via the rotational movements of the rotatable posts 21. Preferably, at least one of the rotatable joints 21 is incorporated with a locking mechanism 210, such as a fastening screw or locking bolt, that locks up the rotational movement of the rotatable joint 21, such that once the corresponding rolling back massaging face 201 is selected and oriented, the locking mechanism 210 will releasably locked to prevent the rotation of rolling back massaging post 22.

As shown in FIG. 1, the rolling back massaging faces 201 are defined at mid-portions of the rolling back massaging posts 22 respectively. In particular, the rolling back massaging face 201 is integrally provided at the corresponding rolling back massaging post 22 to form a one single layered structure with this built-in configuration. It is worth mentioning that different rolling back massaging faces 201 provide different massaging abilities and strengths for fitting different needs and different areas of the user. In one embodiment, the rolling back massaging faces 201 can be configured to have a non-circular rolling back massaging face, a bead face having a plurality of massaging beads, a convex rolling back massaging face, and a spherical rolling back massaging face, the curved bar of outward arch at intermediate section, semicircular and the other half of the triangle at cross-section. For example in FIG. 5, the mid-portion of the rolling back massaging post 22, i.e. between the upper and bottom ends, has a non-circular cross section, such as triangular cross section, rectangular cross section, or prism cross section, to form the non-circular rolling back massaging face 201. In one embodiment, a plurality of massaging beads are provided at the mid-portion of the rolling back massaging post 22 to form the rolling back massaging face 201 with the bead face. In another embodiment, two ends of a convex bar, such as an outward arched member, are coupled at the mid-portion of the rolling back massaging post 22 to form the convex rolling back massaging face 201.

Each of the handle units 31 comprises a handle support 311 coupled between the upper frame 11 and the lower frame 12, and a handle member 312 extended from the handle support for being gripped by the user's hand. Therefore, the user, especially the elder user, is able to grip the handle members 312 to perform the flexing and extending movement. Preferably, the handle support 311 is rotatably coupled between the upper frame 11 and the lower frame 12, such that the handle units 31 are pivotally coupled between the upper frame 11 and the lower frame 12. Accordingly, the handle members 312 are pivotally folded with respect to the supporting frame 10 to selectively adjust a distance between the handle members 312. The distance adjustment between the handle members 312 will ensure the proper hand grip positions of the user during the flexing and extending movement. In addition, each of the handle units 31 further comprises a ground stopper 313 provided at the handle member 312 for detachably biasing against the ground surface to retain the handle member 312 in position. In other words, the ground stoppers 313 are actuated to lock up the distance between the handle members 312. It is appreciated that the handle unit 31 is detachably coupled between the upper frame 11 and the lower frame 12 by slidably inserting upper and lower ends of the handle supports 311 to the outer ends of the upper frame 11 and the lower frame 12.

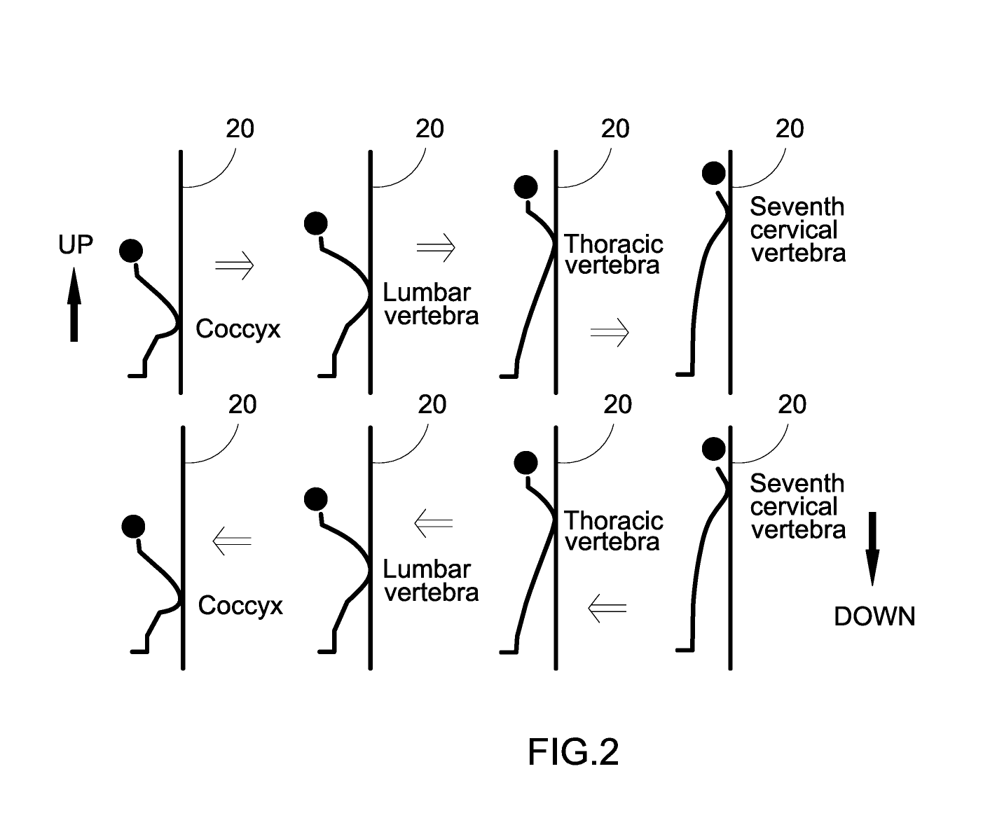

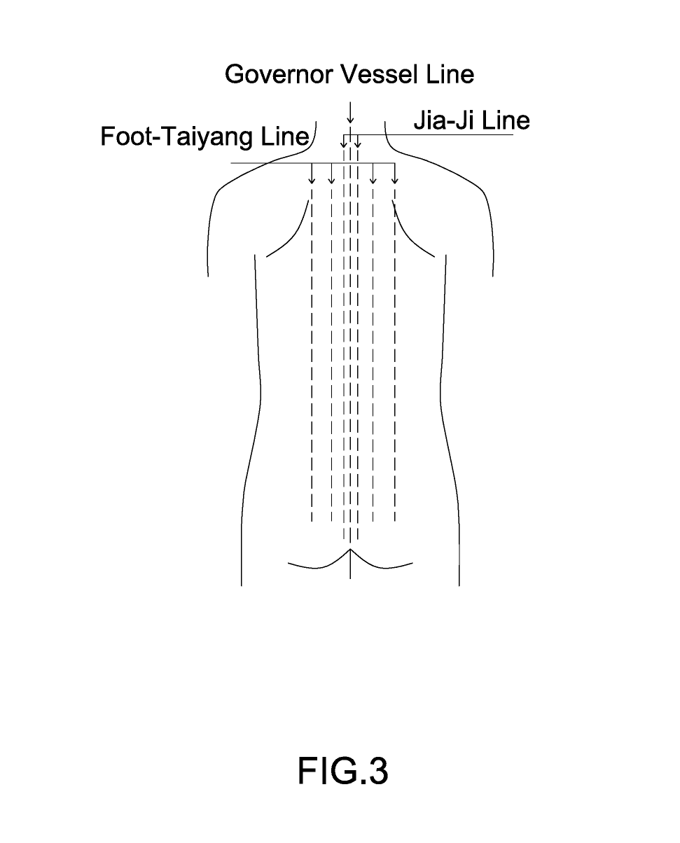

In one embodiment, the handle member 312 is parallel to the handle support 311 that a distance between the handle member 312 and the handle support 311 is uniform. When the user grips the handle members 312, the handle members 312 are used for guiding the user to perform the flexing and extending movement by sliding the hands of the user along the handle members 312 in an up-and-down direction. Especially for the elder user, the user can keep his or her balance during the flexing and extending movement. At the same time, different points at the user's back will be touched, rubbed and/or kneaded during the flexing and extending movement. As shown in FIG. 2, coccyx, lumbar vertebra, thoracic vertebra, and seventh cervical vertebra will be touched, rubbed and/or kneaded during the flexing and extending movement. It is worth mentioning that there are seven vertical lines of massaging meridians, i.e. four Foot-Talyang lines, one Governor vessel line, and two Jia-Ji lines, are spacedly defined at the user's back, as shown in FIG. 3. The user is able to self-adjust the body position to align the rolling back massaging post 22 to align with one of the massaging lines of the user's back so as to ensure the rolling back massaging face 201 to contact with the massaging line.

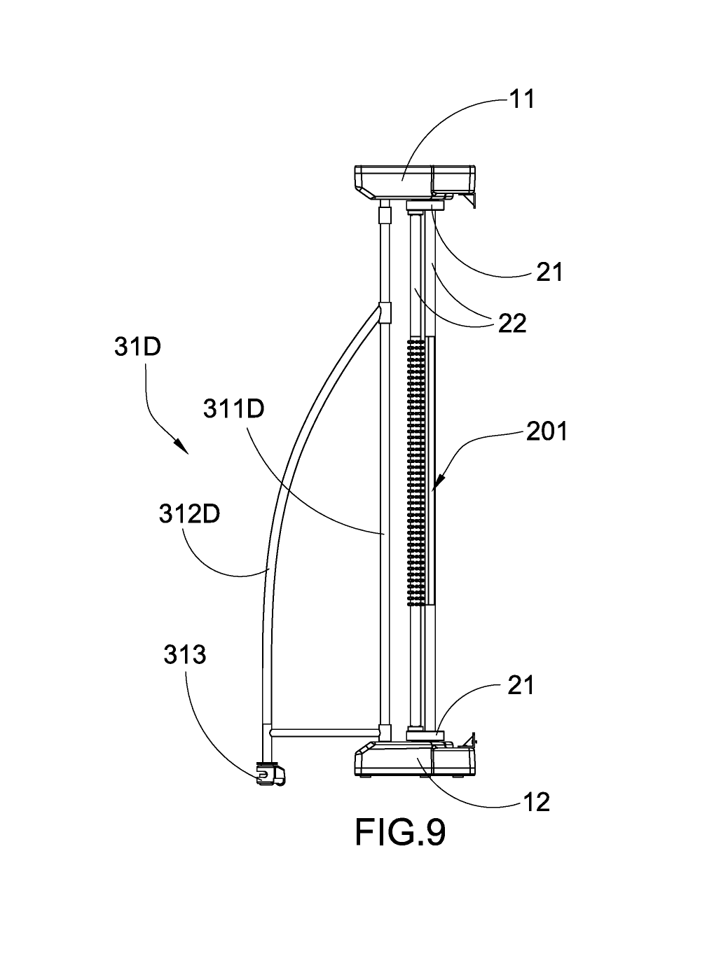

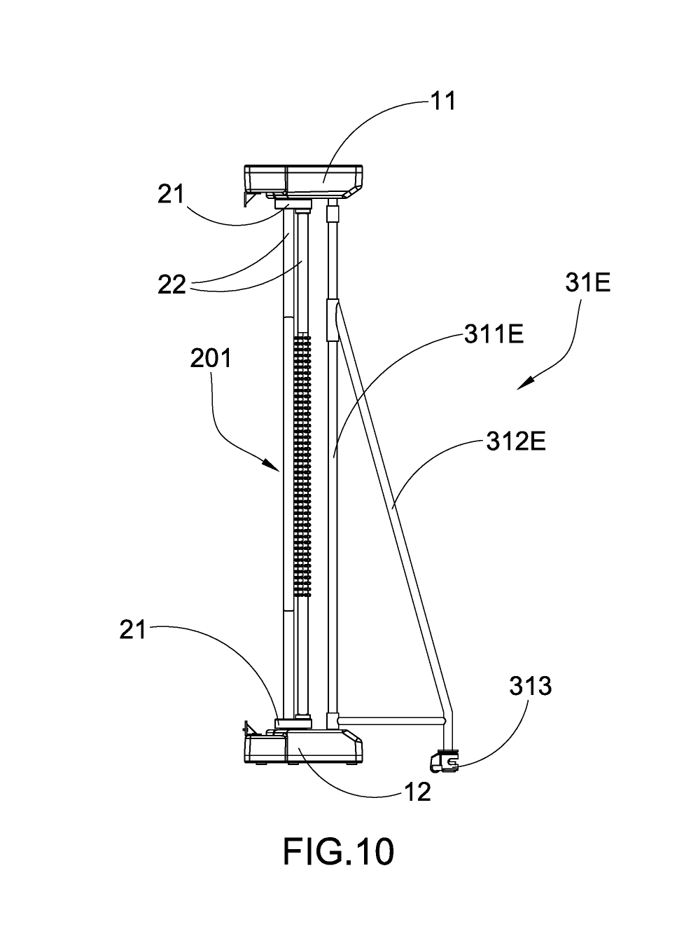

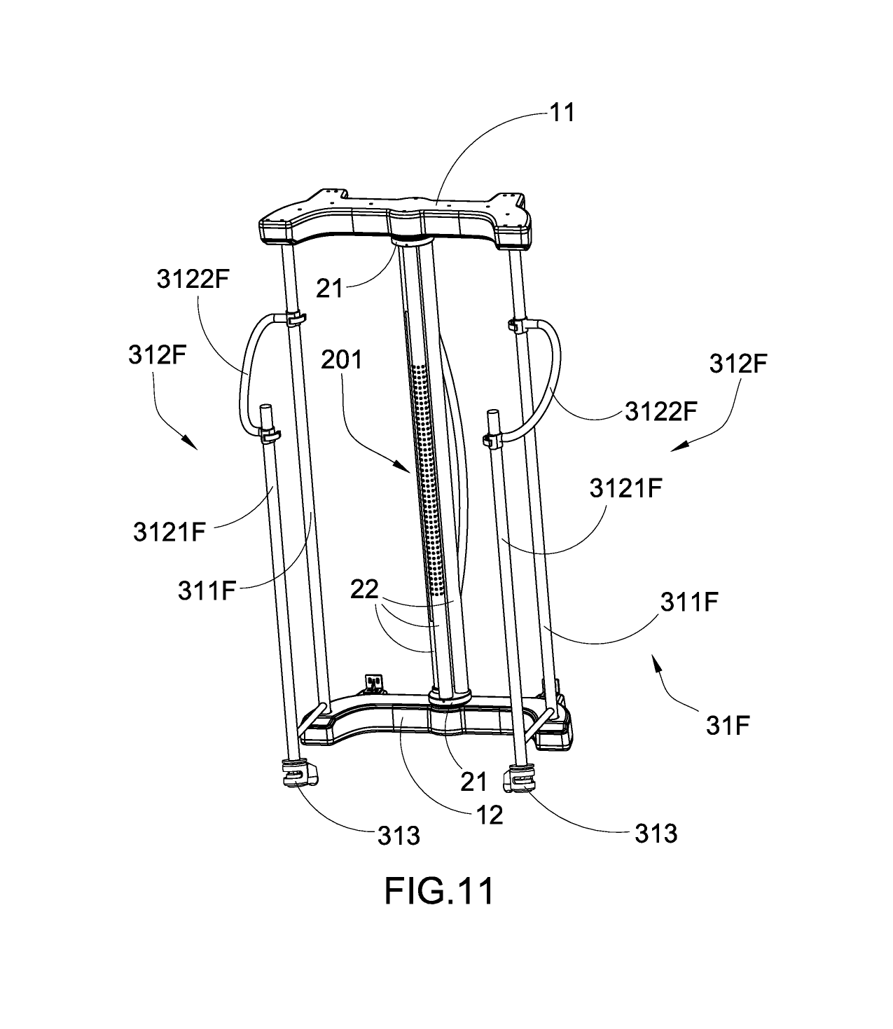

FIG. 9 illustrates an alternative mode of the handle unit 31D, wherein the handle member 312D is a curved member that a distance between the handle member 312D and the handle support 311D is increased toward the lower frame 12. Therefore, during the flexing and extending movement, the user will also stretch the arms at the downward body movement along the curved handle member 312D. Likewise, the handle member 312E is a slanted member that a distance between the handle member 312E and the handle support 311E is increased toward the lower frame 12, as shown in FIG. 10, such that during the flexing and extending movement, the user will also stretch the arms at the downward body movement along the curved handle member 312E. It is appreciated that the handle unit 31F can be configured, as shown in FIG. 11, that the handle member 312F has a length shorter than a length of the handle support 311F, wherein the handle member 312F comprises a vertical handle element 3121F upwardly extended from the lower frame 12 toward the upper frame 11 and an outward curving element 3122F extended between an upper end of the vertical handle element 3121F and the handle support 311F, such that the handle units 31F form a boundary frame to prevent the user, especially the elder user, accidentally falling out of the supporting frame 10. It is worth mentioning that the outward curving element 3122F is slidably coupled between the vertical handle element 3121F to the handle support 311F to selectively adjust an elevation level of the outward curving element 3122F.

It is worth mentioning that when the user grips the handle member 312, the user is able to apply an arm force to push the user's body backward so as to self-apply the massaging pressure on the user's back at the rolling back massaging face 201. By increasing the backward pushing force by the user, the massaging pressure will be correspondingly increased. Therefore, the loading capacity of the user's back, such as the spine, in the health campaigns.

In order to operate the rolling healthcare massage and fitness apparatus, the present invention provides a method of guiding a user to perform a flexing and extending movement and to back-massage at the same time, comprising the following steps.

(1) Support the upper frame 11 above the lower frame 12. Preferably, both the upper and lower frames 11, 12 are affixed to the wall surface.

(2) Provide two handles unit 31 between the upper frame 11 and the lower frame 12 for guiding the user to perform the flexing and extending movement by griping the user's hands at the handle units 31.

(3) Extend the rolling back massaging arrangement 20 between the upper frame 11 and the lower frame 12 at a position that the rolling back massaging arrangement is located between the handle units 31. Preferably, the user is able to select one of the rolling back massaging faces for touching, rubbing and kneading on the user's back during the flexing and extending movement.

According to the present invention, there are two main purposes that the user can achieve at the same time. Firstly, the user spinal flexing motion and the effects of “loading capacity” of spine in the health campaigns. In flexing and extending movement, the legs and trunk are together within the action that the legs movements drive upper body to rolling body's back to achieve healthcare massage. At the same time, the crowded force of the rolling back massaging face 201 on the spinal bone produces the effects of the loading capacity on spine, that increase the density of spinal bone. Secondly, the stimulating effects of acupoints and meridians on body's back. Looking at acupuncture of meridian theory and the healthcare massage, they are the same way to stimulate the body's acupoints to dredge the meridians purposes. Acupuncture for depth and strong stimulation can play a therapeutic role. Relatively for acupuncture, the healthcare massage is as shallow and weak stimulation that can play healthcare role. The features of the present invention are the same as acupuncture and the massage that human back pressures on the rolling back massaging face 201 to stimulate acupoints and meridian, to achieve the effects of healthcare massage. Specific for disc health, the present invention provides a comprehensive approach to promote spinal health and prevent disc early irreversible degenerative changes that is overall to promote spinal health from two categories of “Fitness” and “Healthcare”.

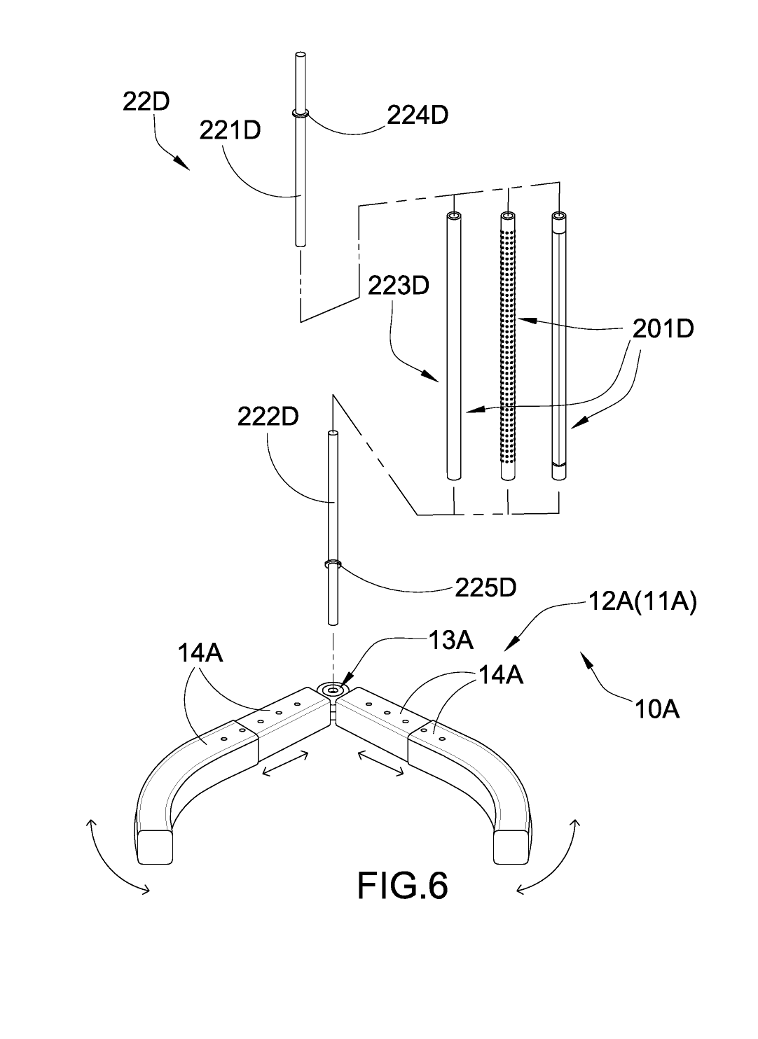

FIG. 6 illustrates an alternative mode of the supporting frame 10A which is a foldable frame. Accordingly, each of the upper frame 11A and the lower frame 12A comprises a pivot joint 13A and two folding arms 14A pivotally extended therefrom. Therefore, the folding arms 14A can be pivotally folded via the pivot joint 13A towards each other to fold up the supporting frame 10A and can be pivotally moved end-to-end to unfold the supporting frame 10A. It is worth mentioning that the rolling back massaging arrangement 20 is extended between the pivot joints 13A of the upper frame 11A and the lower frame 12A. In order to further reduce the overall size of the supporting frame 10A at the folded position, each of the folding arms 14A is a telescoping arm to selectively adjust a length of the folding arm 14A from the pivot joint 13A. It is worth mentioning that each of the handle units 30 is extended between the outer ends of the upper frame 11A and the lower frame 12A. Through the telescoping arm, a distance between each of the handle units 31 and the rolling back massaging arrangement 20 can be selectively adjusted.

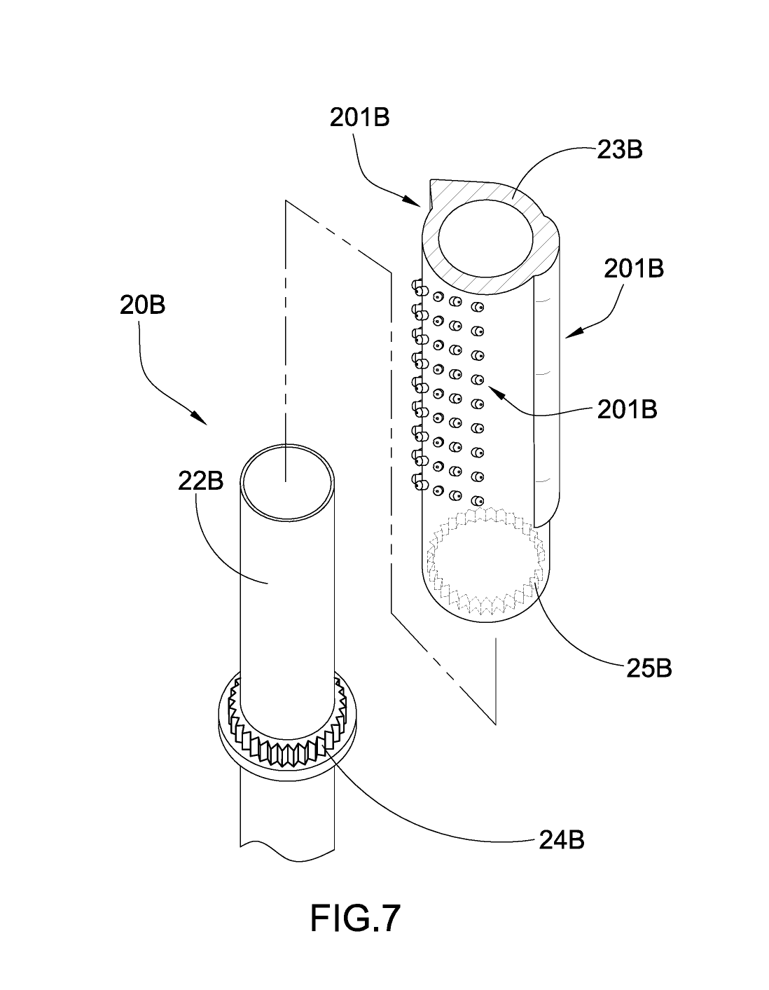

FIG. 7 illustrates an alternative mode of the rolling back massaging arrangement 20B which comprises one rolling back massaging post 22B non-rotatably extended between the upper frame 11 and the lower frame 12, and a massaging sleeve 23B rotatably coupled at outside of the rolling back massaging post 22B at the mid-portion thereof to form a two-layered structure, i.e. the rolling back massaging post 22B and the massaging sleeve 23B. Accordingly, the rolling back massaging faces 201B are formed at an outer circumferential surface of the massaging sleeve 23B, such that the massaging sleeve 23B is rotated to orient the corresponding rolling back massaging face 201B for touching, rubbing and/or kneading on the user's back.

In addition, the rolling back massaging arrangement 20B further comprises a first engaging element 24B provided at an outer circumferential surface of the rolling back massaging post 22B and a second engaging element 25B provided at an inner circumferential surface of the massaging sleeve 23B to detachably engage with the first engaging element 24B so as to retain the corresponding rolling back massaging face 201B at a desired orientation. In other words, when the massing sleeve 23B is slid along the rolling back massaging post 22B to disengage the second engaging element 25B with the first engaging element 24B, the massaging sleeve 23B is adapted to be rotated around the rolling back massaging post 22B to selectively orient the corresponding rolling back massaging face 201. In one embodiment, the first and second engaging elements 24B, 25B are two teeth gear-configured elements, wherein the teeth engagement between the first and second engaging elements 24B, 25B will ensure the corrected alignment of each of the rolling back massaging face 201 to face toward the user's back.

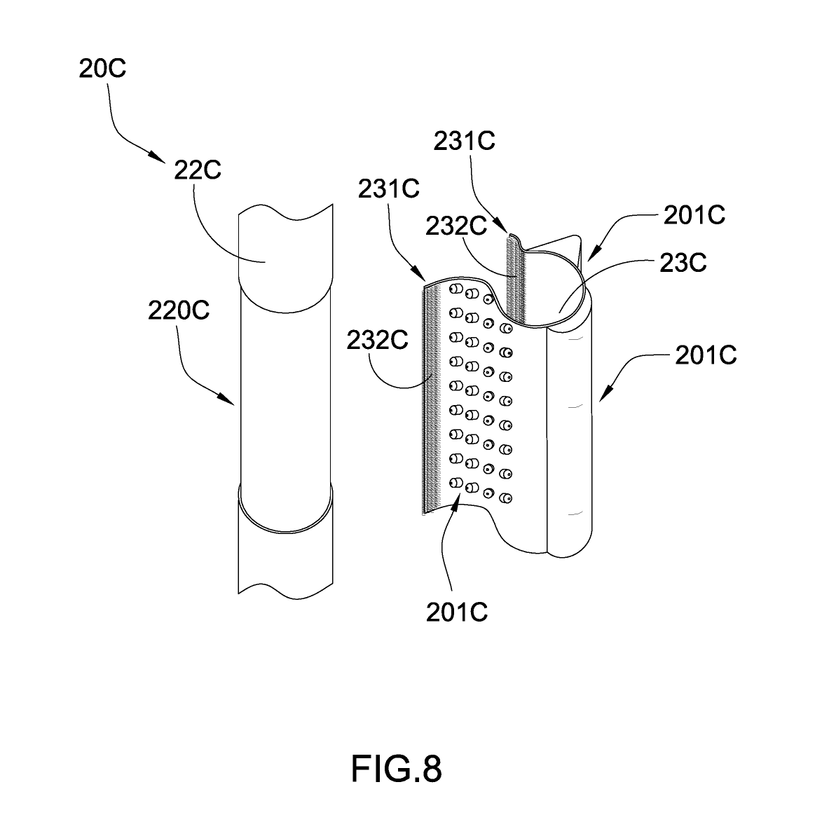

FIG. 8 illustrates another alternative mode of the rolling back massaging arrangement 20C which comprises a rolling back massaging post 22C non-rotatably extended between the upper frame 11 and the lower frame 12, and a massaging sleeve 23C detachably coupled at the rolling back massaging post 22C, wherein the rolling back massaging faces 201C are formed at an outer circumferential surface of the massaging sleeve 23C to form a two-layered structure, i.e. the rolling back massaging post 22C and the massaging sleeve 23C. Therefore, the massaging sleeve 23C is detachably coupled at the rolling back massaging post 22C at the mid-portion thereof to orient the corresponding rolling back massaging face 201C for touching, rubbing and/or kneading on the user's back.

Accordingly, the massaging sleeve 23C has two detachable edges 231C and two fasteners 232C provided thereat respectively to allow the massaging sleeve to be detached from the rolling back massaging post 22C and to be re-coupled at the rolling back massaging post 22C for changing the rolling back massaging faces 201C. Preferably, the fasteners 232C are hook-and-loop fasteners. Other fasteners can be used as long as the detachable edges 231C of the massaging sleeve 23C can be detachably coupled with each other to form the massaging sleeve 23C in a tubular configuration for encircling around the rolling back massaging post 22C. Preferably, the rolling back massaging post 22C has an indented cavity 220C formed at the mid-portion thereof, wherein the indented cavity 220C is indented on the circumferential surface of the rolling back massaging post 22C to guide and receive the massaging sleeve 23C. The size of the indented cavity 220C matches with the length of the massaging sleeve 23C to ensure the massaging sleeve 23C to fit around the rolling back massaging post 22C.

FIG. 6 further illustrates a third alternative mode of the rolling back massaging arrangement which comprises a rolling back massaging post 22D extended between the upper frame 11 and the lower frame 12. Preferably, the rolling back massaging post 22D is detachably coupled between the upper frame 11 and the lower frame 12 by inserting the upper and lower ends of the rolling back massaging post 22D into the upper frame 11 and the lower frame 12 respectively.

As shown in FIG. 6, the rolling back massaging post 22D comprises a upper post 221D downwardly extended from the upper frame 11, a lower post 222D upwardly extended from the lower frame 12, and a connector post 223D detachably coupled between the upper post 221D and the lower post 222D, wherein the rolling back massaging face 201D is formed at the connector post 223D. In one embodiment, there are three connector posts 223D selectively and detachably coupled between the upper post 221D and the lower post 222D, wherein the rolling back massaging faces 201C are formed the connector posts 223D. Therefore, the user is able to select the rolling back massaging face 201D by coupling the corresponding connector post 223D between the upper post 221D and the lower post 222D.

In one embodiment, the diameter size of the upper post 221D is the same as the diameter size of the lower post 222D, wherein the diameter size of the connector post 223D is larger than the diameter size of each of the upper post 221D and the lower post 222D. Therefore, the upper post 221D and the lower post 222D are coaxially inserted into the connector post 223D end-to-end. In other words, the lower end of the upper post 221D is coaxially inserted into the upper end of the connector post 223D and the upper end of the lower post 222D is coaxially inserted into the lower end of the connector post 223D. Preferably, an upper stopper 224D is provided at the upper post 221D and a lower stopper 225D is provided at the lower post 222D, wherein when the upper post 221D and the lower post 222D are coaxially inserted into the connector post 223D end-to-end, the upper end and the lower end of the connector post 223D are blocked by the upper stopper 224D and the lower stopper 225D respectively, so as to retain the connector post 223D between the upper post 221D and the lower post 222D.

It is worth mentioning that the above mentioned embodiment and its alternatives can be interchangeable. For example, the “non-rotatable” rolling back massaging post 22B, 22C can be incorporated with the curved handle member 321D or the slanted handle member 312E.

Accordingly, the present invention has a features of “Fitness+Healthcare”, and also has a simple structure, convenient and effective, self-help healthcare massage and other advantages:

(1) Innovative device of healthcare massage: Using the healthcare massage and fitness apparatus requires the movements of human legs and torso in order to achieve the effect of the body back massage. This is a new self-help equipment that physical exercises combined with the body back healthcare massage.

(2) Enhancing spinal health and spine anti-aging: Prof. Dr. Juergen Kraemer said, “Spinal degenerative changes and intervertebral disk diseases are as old as humanity itself.” “Histological studies regularly show degenerative changes in all structural components of the intervertebral disk beginning in the third decade of life, with cell degeneration, cell loss, fiber degeneration, and loosening of the matrix.” “A regular alternation of mechanical stress and relaxation aids intradiscal metabolism, but a constantly maintained posture-particularly one in which the spine is under stress-impairs it.” Using the equipment of the rolling back healthcare massage, the forward bent of the body and the back extension can change the overall mechanical pressure of lumbar intervertebral disc, and improve disc nutrition. This will slow down and improve the human necessity of early degenerative changes of the intervertebral disc.

(3) Preventing and improving displacement of spinal bone. When the rolling back healthcare massage reverse back scrolls along the Jia-Ji acupoints, it can adjust the tension of spine ligaments and muscles on both sides, can correct the spinal side displaced state and, prevent and improve the spinal dislocation. Additionally, the spine and intervertebral disk extrusion and stretching can improve blood circulation and supply nutrients to intervertebral disk, assist the spine with obtaining nutrients, can prevent ossification of spinal ligament, muscle atrophy, joint stiffness and osteoporosis.

(4) Self-help massage: The healthcare massage and fitness apparatus does not need others to help, only needs to rely on their own leg strength and flexing and extending movements of the upper body, then will be able to achieve on their own back massage. The using of the rolling back healthcare massage and fitness apparatus can massage 126 acupoints in once exercise.

(5) Controllable and security: In the rolling back healthcare massage, the pressure on rolling back massaging arrangement, and the length of time for each exercise and massage, you can control all of them by yourself. The left and right sides of the handle to facilitate hand held to prevent falls.

(6) Simple, easy to use: The composition of healthcare massage and fitness apparatus has the rolling back massaging posts and fixed upper and lower frames only, and without any button operation. Easy to fixed to the wall or upright support bracket, and no special requirements for the space. The healthcare massage and fitness apparatus has a different pole's shapes to meet different individual requirements of each physique, and easy to operate.

(7) Natural environmental protection: No electric auxiliary mechanical, no chemical substances.

(8) Economic and benefits: Low cost, one-time purchase at home, and can use all year round. There is no post-maintenance costs. Family members are free to arrange time to rolling back healthcare massage. Thus, it is a universal. The ordinary people can use, especially in the elderly.

(9) The adaptation to a wide range: Due to human birth defects of the spine, the spine degenerative changes in the beginning about the age of 20. Therefore, the healthcare massage and fitness apparatus applies equally to young people age of 20 and over. In rolling back massage, the degree of leg flexing and extending and upper body portion can be adjusted according to their physical condition. Therefore, this new fitness equipment for a wide range of people, and even more than 100 years of longevity.

(10) Easy to understand: The line along the central spine is Governor Vessel. Along the middle line of the spine and blades edge, then along the edge line of the blades is Bladder Meridian of Foot-Taiyang. The meridian and acupoints of the back locates the center and both side of symmetry. Easy to learn and master.

(11) Definite healthcare effects: This invention focuses on the human back massage of three important meridians and acupoints. Using the body's own leg strength along the points of the back and the action of body flexing and extending to achieve the purpose of back massage. This is innovative concept of “Fitness+Healthcare” and practices. It is to enhance physical fitness, prevent disease, improve spinal age-related diseases associated with aging and has a positive meaning.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A rolling back healthcare massage and fitness apparatus for a user to perform a flexing and extending movement and to back-massage at the same time, comprising:
a supporting frame which comprises an upper frame and a lower frame;
a rolling back massaging arrangement extended between said upper frame and said lower frame, wherein said rolling back massaging arrangement comprises one or more rolling back massaging posts extended between said upper and lower frames, and one or more rolling back massaging faces provided at one or more of said rolling back massaging posts, wherein one of said rolling back massaging faces is interchangeable and selectively oriented for touching, rubbing and kneading on the user's back; and
a handle frame which comprises two handle units spacedly extended between said upper frame and said lower frame at a position that said rolling back massaging arrangement is located between said handle units, wherein said handle units are arranged not only for allowing the user's hands to hold at said handle units to perform the flexing and extending movement but also for enabling the user's body to push backward so as to self-apply a massaging pressure on the user's back at one of said rolling back massaging faces for back-massaging.

2. The rolling back healthcare massage and fitness apparatus, as recited in claim 1, wherein said rolling back massaging arrangement comprises two rotatable joints rotatably coupled at said upper frame and said lower frame, wherein two or more of said rolling back massaging posts are coupled between said rotatable joints that said rolling back massaging faces are formed at said rolling back massaging posts respectively, such that said rotatable joints are rotated to selectively move one of said rolling back massaging posts to orient said corresponding rolling back massaging face for rubbing and kneading on the user's back.

3. The rolling back healthcare massage and fitness apparatus, as recited in claim 2, wherein each of said rotatable joints comprises a turntable rotatably coupled at said corresponding upper frame and said lower frame, wherein said rolling back massaging posts are spacedly coupled at a circumferential portion of said turntable to selectively orient said corresponding rolling back massaging face.

4. The rolling back healthcare massage and fitness apparatus, as recited in claim 1, wherein said rolling back massaging post is non-rotatably extended between said upper frame and said lower frame, and a massaging sleeve rotatably coupled at said rolling back massaging post that said rolling back massaging faces are formed at an outer circumferential surface of said massaging sleeve, such that said massaging sleeve is rotated to orient said corresponding rolling back massaging face for touching, rubbing and kneading on the user's back.

5. The rolling back healthcare massage and fitness apparatus, as recited in claim 4, wherein said rolling back massaging arrangement further comprises a first engaging element provided at an outer circumferential surface of said rolling back massaging post and a second engaging element provided at an inner circumferential surface of said massaging sleeve to detachably engage with said first engaging element so as to retain said corresponding rolling back massaging face at a desired orientation, such that when said massing sleeve is slid along said rolling back massaging post to disengage said second engaging element with said first engaging element, said massaging sleeve is adapted to be rotated around said rolling back massaging post to selectively orient said corresponding rolling back massaging face.

6. The rolling back healthcare massage and fitness apparatus, as recited in claim 1, wherein said rolling back massaging arrangement a rolling back massaging post non-rotatably extended between said upper frame and said lower frame, and a massaging sleeve detachably coupled at said rolling back massaging post that said rolling back massaging faces are formed at an outer circumferential surface of said massaging sleeve, such that said massaging sleeve is detachably coupled at said rolling back massaging post to orient said corresponding rolling back massaging face for touching, rubbing and kneading on the user's back.

7. The rolling back healthcare massage and fitness apparatus, as recited in claim 6, wherein said massaging sleeve has two detachable edges and two fasteners provided thereat respectively to allow said massaging sleeve to be detached from said rolling back massaging post and to be re-coupled at said rolling back massaging post for changing said rolling back massaging faces.

8. The rolling back healthcare massage and fitness apparatus, as recited in claim 1, wherein said supporting frame is a foldable frame that each of said upper frame and said lower frame comprises a pivot joint and two folding arms pivotally extended therefrom.

9. The rolling back healthcare massage and fitness apparatus, as recited in claim 8, wherein said rolling back massaging arrangement is extended between said pivot joints of said upper frame and said lower frame, wherein each of said handle units is extended between outer ends of said upper frame and said lower frame.

10. The rolling back healthcare massage and fitness apparatus, as recited in claim 9, wherein each of said folding arms is a telescoping arm to selectively adjust a distance between each of said handle units and said rolling back massaging arrangement.

11. The rolling back healthcare massage and fitness apparatus, as recited in claim 1, wherein said supporting frame is a stationary frame adapted for affixing to a wall surface, wherein said rolling back massaging arrangement is extended between mid-portions of said upper frame and said lower frame, wherein each of said handle units is extended between outer ends of said upper frame and said lower frame.

12. The rolling back healthcare massage and fitness apparatus, as recited in claim 11, wherein said handle units are pivotally coupled between said upper frame and said lower frame.

13. The rolling back healthcare massage and fitness apparatus, as recited in claim 1, wherein each of said handle units comprises a handle support rotatably coupled between said upper frame and said lower frame, and a handle member extended from said handle support for being gripped by the user's hand, such that said handle members are pivotally folded with respect to said supporting frame to selectively adjust a distance between said handle members.

14. The rolling back healthcare massage and fitness apparatus, as recited in claim 13, wherein said handle members are pivotally folded to said supporting frame at a position that said rolling back massaging arrangement is positioned between said handle members.

15. The rolling back healthcare massage and fitness apparatus, as recited in claim 13, wherein said handle member is a curved member that a distance between said handle member and said handle support is increased toward said lower frame.

16. The rolling back healthcare massage and fitness apparatus, as recited in claim 13, wherein said handle member is a slanted member that a distance between said handle member and said handle support is increased toward said lower frame.

17. The rolling back healthcare massage and fitness apparatus, as recited in claim 13, wherein said handle member is parallel to said handle support that a distance between said handle member and said handle support is uniform.

18. The rolling back healthcare massage and fitness apparatus, as recited in claim 1, wherein said rolling back massaging faces are at least two of, non-circular rolling back massaging face, a bead face having a plurality of massaging beads, a convex rolling back massaging face, and a spherical rolling back massaging face.

19. A flexing and extending exercising apparatus for a user to perform a flexing and extending movement, comprising:
a supporting frame which comprises an upper frame and a lower frame;
a handle frame which comprises two handle units spacedly extended between said upper frame and a lower frame, wherein said handle units are arranged for guiding the user to perform a flexing and extending movement by griping the user's hands at said handle units; and
a built-in rolling back massaging arrangement extended between said upper frame and said lower frame, wherein said rolling back massaging arrangement comprises one or more of rolling back posts and one or more rolling back massaging faces provided at said rolling back post for touching, rubbing and kneading on the user's back during the flexing and extending movement, such that said rolling back massaging arrangement is arranged for enabling the user to self-apply a massaging pressure on the user's back at said rolling back massaging face for back-massaging during the flexing and extending movement.

20. The flexing and extending exercising apparatus, as recited in claim 19, wherein said rolling back massaging post is extended between said upper frame and said lower frame, wherein said rolling back massaging post has one layer structure that said rolling back massaging face is integrally formed at said rolling back massaging post.

21. The flexing and extending exercising apparatus, as recited in claim 19, wherein said rolling back massaging post is extended between said upper frame and said lower frame, wherein said rolling back massaging post has two or more layer structure that said rolling back massaging face is separately formed at said rolling back massaging post.
